(19) United States
(12) Patent Application Publication
(10) Pub. No.: US 2008/0229351 A1
(43) Pub. Date: Sep. 18, 2008

(54) Display device and remote control device for the same

(75) Inventor: Hiroshi Torimaru, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/076,271

(22) Filed: Mar. 14, 2008

(30) Foreign Application Priority Data
Mar. 15, 2007 (JP) 2007-66520

(51) Int. Cl. H04N 7/16; H04N 5/44

(52) U.S. Cl. 725/14; 348/734

(57) ABSTRACT

A display device collects pieces of EPG information, stores the program information of a viewed program as a piece of viewing history information, counts the number of occurrences of each of categories in viewing history information and calculates the priority of each category based on the number of occurrences, and stores it in a priority information storage unit. Then, the display device selects one or more programs in a category having the highest priority based on the pieces of program information of programs currently being broadcasted and priority information at power-on, displays the selected programs in thumbnail screens on a display and, if one of the thumbnail screens is selected as an object to be viewed, switches the display screen for the program to a normal screen.

### CROSS-REFERENCE TO RELATED APPLICATIONS

This application claims priority from Japanese patent application Ser. No. 2007-066520 filed Mar. 15, 2007, the contents of which are incorporated by reference herein.

### BACKGROUND OF THE INVENTION

1. Field of the Invention

The present invention relates to a display device having a function of receiving and displaying, among broadcast programs, a program favored by a viewer (hereinafter referred to as a user) using information on the broadcast programs and to a remote control device which transmits an instruction signal to the display device.

2. Description of the Related Art

In a display device such as a television set which receives and displays a broadcast program, broadcast stations are assigned to respective channels of the television set. For this reason, a user needs to check a channel on which a desired program is to be broadcasted and the broadcast date and time of the program in advance and select the channel.

In recent years, television sets having a function of receiving broadcast program information such as EPG (Electronic Program Guide) have become widespread. EPG is distributed over the airwaves or the Internet. EPG information includes a genre/category, e.g. sports, drama, and news, which is set by a broadcast program distributor in addition to information such as the broadcast date, broadcast start and end times, broadcasting station, program titles such as series tile and episode titles, performers, and synopsis of each program. Since a television having an EPG reception function can display not only a program schedule for each channel but also a program schedule based on a predetermined genre/category using EPG, a user can select a desired program by genre/category.

However, in any case, a user needs to check when a desired program is to be broadcasted and select a corresponding channel. At power-on, a common television selects a channel selected when the television is turned off last time. For this reason, a channel selected at power-on is not always a channel which a user wants to select at the time of viewing, and the user often needs to switch channels.

To cope with this, there is known a television identifies a channel considered to be most often selected by a user as a “favorite channel” and set the favorite channel in a remote control unit for channel selection, then on a power-on of the television, the “favorite channel” is automatically selected to display a program being broadcasted on the channel (see, e.g., Patent Document 1: Japanese Patent Laid-Open No. H10-336535).

However, a CS (communication satellite)-based or cable-based multi-channel program distribution system has recently been in widespread use, and a channel preset as a “favorite channel” as disclosed in Patent Document 1 is not always a channel desired by a user.

Furthermore, a user still needs to know, in advance, on which one of channels including the “favorite channel” a desired program is being broadcasted. Unless the desired program is broadcasted on the “favorite channel”, the user cannot save checking and selecting a channel to watch the desired program. Although EPG program schedule is helpful in looking for a broadcast program, it cannot save the channel selection operation itself.

In CS or cable based multi-channel program distribution systems which have recently become widespread, checking on which channel a desired program is being broadcasted itself is troublesome. For example, programs are broadcasted at broadcast times flexibly set by broadcast program distributors, and thus a program schedule is complicated. Additionally, since a set of program genres/categories vary from distributor to distributor, it is difficult to find a desired program. Therefore, there is a demand for a mechanism which allows a user to view a favorite broadcast program without fail even if the user does not know a broadcast date and the like in advance.

### SUMMARY OF THE INVENTION

It is an object of the present invention to provide a display device which aids a user in broadcast program viewing by preferentially displaying a program considered to be favored by the user based on a history information of viewing broadcast programs or to provide a remote control device for the display device.

The display device comprises a priority calculation unit, a displayed program control unit, and a program display processing unit. The priority calculation unit of the display device counts the number of occurrences of each of categories into which viewed programs fall, namely the total number of programs in the category viewed in the past, by using viewing history information of the viewed programs and calculates a priority of the category based on the number of occurrences. The displayed program control unit obtains a piece of program information of each of programs which are currently being broadcasted, identifies one of the categories which has a highest priority, then selects and displays at least one program in the category among the currently broadcasted programs, upon occurrence of a predetermined event serving as a trigger, e.g. at power-on event.

The display device can display a broadcast program in a category, at a time of viewing, among categories into which programs viewed by a user in the past are classified to notify the user of broadcast of a program that the user would desire to view. Even if a user does not know on which channel a program in a favorite category is being broadcasted, the user can avoid missing a desired program.

As another aspect of the present invention, the display device further comprises a program feature information storage unit and a program feature extraction unit. The program feature information storage unit stores correspondence information indicating a correspondence relationship between each of subcategories into which programs are classified based on content and a word (feature word), e.g. a program title, performer's name, which occurs in a piece of program information of a program classified into the subcategory and represents a feature of content of the program.

The program feature extraction unit of the display device obtains information of each of programs being broadcasted upon occurrence of a predetermined event serving as a trigger, extracts a feature word representing a feature of content of the program from the pieces of program information of the programs being broadcasted and the pieces of viewing history information of the viewed programs. Then, for each of the programs being broadcasted and the viewed programs, the program feature extraction unit identifies a subcategory into which the program falls based on the correspondence information. The priority calculation unit counts the number of occurrences of each of the subcategories, which are equivalent to the total number of programs in the subcategory viewed in the past, in the pieces of viewing history information and calculates a priority of the subcategory based on the number of occurrences. The displayed program control unit identifies one subcategory having a highest priority and selects a program in the identified subcategory from among the programs being broadcasted. The program display processing unit displays the selected program on a screen.

The program display processing unit can display one or more of the selected programs in a thumbnail screen of a predetermined size. The program display processing unit can display, as an object to be viewed in a normal sized screen, one program selected from the programs displayed with the thumbnail screen size and terminate displaying the other program displayed with the thumbnail screen size.

Thus, the display device can help a user to chose broadcast programs by using categories which are finer and meet the user's taste more than categories set by program distributors.

As another aspect of the present invention, the display device further comprises a recorded program storage unit and a program recording unit. The recorded program storage unit stores a program recorded by the program recording unit. The program recording unit records a currently broadcasted program which is designated as an object to be recorded and stores the program in the recorded program storage unit. The displayed program control unit can designate a program which is not selected as an object to be viewed and notifies the program recording unit of the selected program as an object to be recorded, when a priority of the program being displayed with the thumbnail screen size and selected as the object to be viewed is not less than a predetermined value.

The display device may be configured to collaborate with a program recording and playback device. Thus, if a priority of a program which is not selected as the object to be viewed and is placed in a non-displayed state is higher than the priority of the program selected as the object to be viewed, the display device can designate the non-displayed program as the object to be recorded and notify the program recording and playback device that the display device collaborates with, of an instruction to record the designated program.

According to the display device, it is also possible to automatically record and save a program which is not selected as an object to be recorded. Even if desired programs conflict with each other, a user can avoid missing one of the desired programs or forgetting to record the desired program.

A remote control device is designed to transmit an instruction signal to the display device, when the display device includes a signal reception unit which receives an instruction signal and a program display processing unit which displays a program indicated by the instruction signal. The remote control device comprises a priority calculation unit, a displayed program control unit, and an instruction signal transmission unit.

The priority calculation unit of the remote control device counts the number of occurrences of each of categories into which viewed programs fall in pieces of viewing history information of the viewed programs and calculates a priority of the category based on the number of occurrences. The displayed program control unit obtains a piece of program information of each of programs being broadcasted, identifies one of the categories which has a highest priority, and selects at least one program in the category from among the programs being broadcasted, upon occurrence of a predetermined event serving as a trigger. The instruction signal transmission unit displays a program title of the selected program and transmits an instruction signal designating a program selected by a user as an object to be viewed to the display device.

The remote control device can transmit an instruction signal for selecting and displaying a program in a category having a high priority based on viewing history information to the display device.

The above-described processes can be realized by a display device or remote control device which incorporates a CPU and a memory and a software program which is installed and executed by the CPU in the device. The program can be stored in an appropriate recording medium such as a CPU-readable portable medium memory or a semiconductor memory. The program is provided by being recorded on such a recording medium or being transmitted-received through a communication interface using various communication networks.

According to the present invention, a user can realize a currently broadcasted program in a desired field when the display device is powered on, even if the user does not know a program schedule in advance. The user is released from troublesome to check a program schedule and select a channel to view a program which meets his/her taste without missing anything. Therefore, the present invention has the effect of significantly improving the usability of a display device that displays a broadcast program.

### BRIEF DESCRIPTION OF THE DRAWINGS

FIG. 1 is a diagram showing an example of a configuration according to the best mode of the present invention;

FIG. 2 is a chart showing an example of the data configuration of EPG information;

FIG. 3 is a chart showing examples of category data, subcategory data, and priority data stored in a priority information storage unit;

FIG. 4 is a chart showing an example of weight setting;

FIG. 5 is an illustration for explaining program selection based on priority;

FIG. 6 is a view showing a display example in a case where programs in a category “A” are displayed with thumbnail screen size;

FIG. 7 is a view showing a display example in a case where programs in a category “B” are displayed with thumbnail screen size;

FIG. 8 is a view showing a display example in a case where a program that has started being broadcasted is displayed with thumbnail screen size when a program is being displayed in a normal screen size;

FIG. 9 is a view for explaining processing in a case where programs with the same priority are displayed with thumbnail screen size;

FIG. 10 is a chart showing examples of the priority of a category or subcategory;

FIG. 11 is a chart showing the outline of the flow of process for a display device;

FIG. 12 is a chart showing the flow of a program presentation process at a time of power-on;

FIG. 13 is a chart showing the flow of a program presentation process when a user is viewing a certain program;

FIG. 14 is a chart showing the flow of a program presentation process upon termination of a program displayed in a normal screen;

FIG. 15 is a diagram showing an example of a configuration according to another embodiment in which a remote control unit is equipped with a program presentation function and a priority updating function; and

FIG. 16 is a view showing examples of an instruction input unit and a display of the remote control unit.

### DETAILED DESCRIPTION OF THE PREFERRED EMBODIMENTS

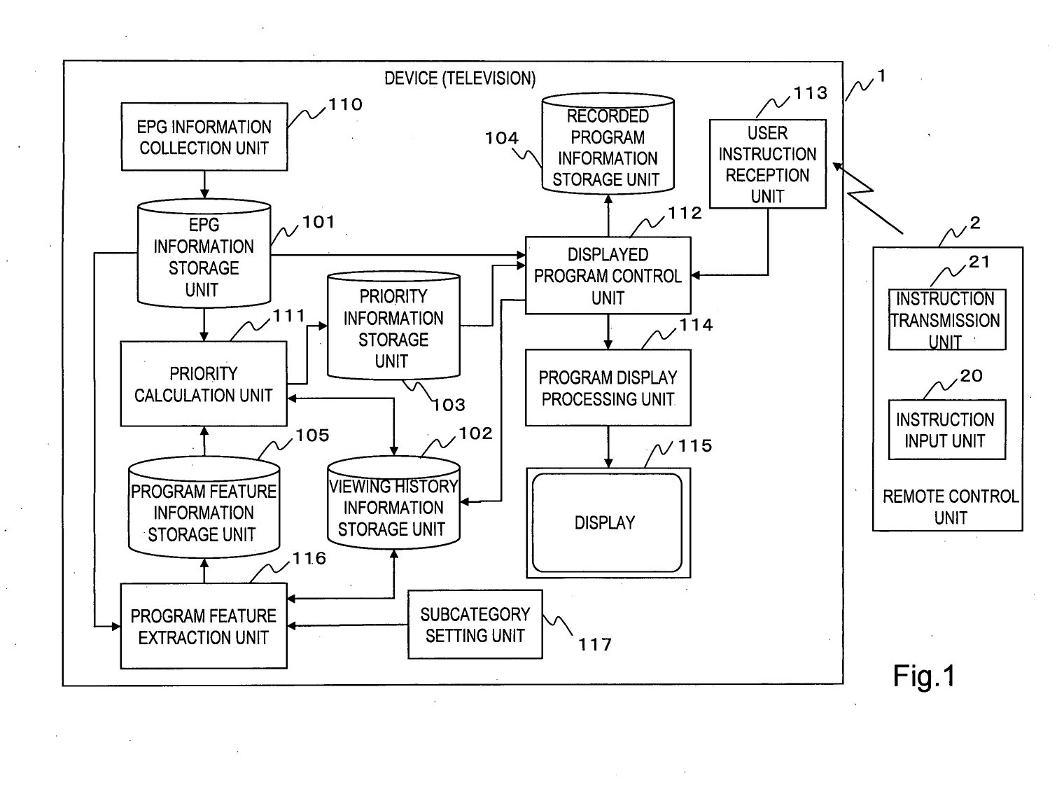

FIG. 1 is a diagram showing an example of a configuration according to the best mode of the present invention.

A device 1 such as a television set (hereinafter referred to as a “television”) receiving and displaying a broadcast program has a favorite program display function corresponds to a display device according to the present invention. The television 1 has a function of receiving an instruction signal from a television remote control unit 2 (hereinafter referred to as a “remote control unit”) corresponds to a remote control device according to the present invention. The television 1 includes an EPG information storage unit 101, a viewing history information storage unit 102, a priority information storage unit 103, a recorded program information storage unit 104, a program feature information storage unit 105, an EPG information collection unit 110, a priority calculation unit 111, a displayed program control unit 112, a user instruction reception unit 113, a program display processing unit 114, a display 115, a program feature extraction unit 116, and a subcategory setting unit 117.

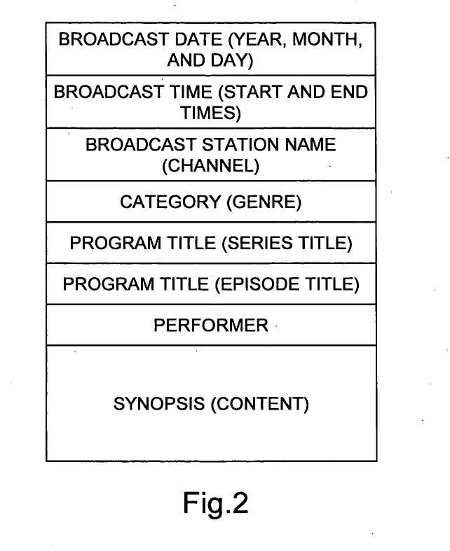

The EPG information storage unit 101 stores program information indicating the content of a broadcasted program. As shown in FIG. 2, EPG information for each program is composed of pieces of information such as a broadcast date, a broadcast time, a broadcast station name (channel), a category, program titles(a series title and a episode title), performers, a synopsis (content), and the like. A category represents a division under which a program is brought by a program distributor based on its content. Examples of categories include sports, drama, movie, and news.

The viewing history information storage unit 102 stores the viewing history information of a program viewed by a user. The viewing history information is generated from the EPG information of the viewed program and additionally includes a subcategory.

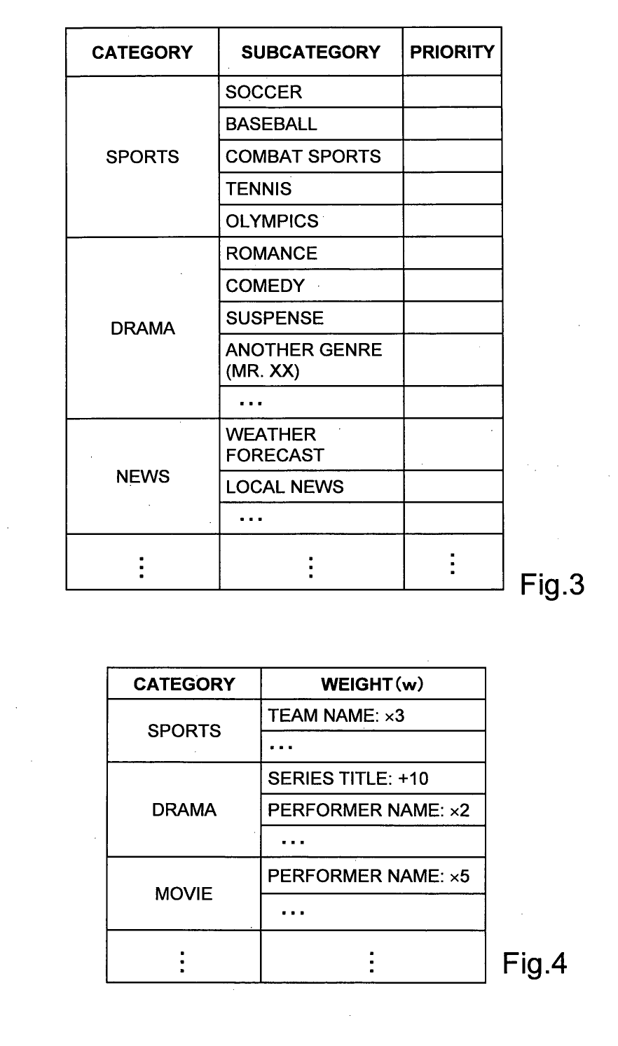

The priority information storage unit 103 stores the priority information of a category or subcategory. A priority is assigned for each of categories and subcategories. A category of a program may be set in EPG information by a program distributor. A subcategory is a finer division of the category and set by a user. As shown in FIG. 3, “sports”, “drama”, “news”, or the like set in EPG information is stored as a category. As subcategories of the “sports” category, “soccer”, “baseball”, “combat sports”, “tennis”, “Olympics”, and the like are stored.

The recorded program information storage unit 104 stores index information of a program recorded by a program recording and playback device which works with the television 1.

The program feature information storage unit 105 stores correspondence information indicating a correspondence relationship between a subcategory and feature words in programs which are classified into the subcategory. A feature word in the correspondence information is a word or phrase that occurs in EPG information as one representing a feature of content of a program. Examples of a feature word are words such as a noun and an adjective contained in program titles (including the title of a series of a program and the title of an episode), performers, and a synopsis (content).

The EPG information collection unit 110 collects pieces of EPG information distributed over the airwaves for broadcast or network like the Internet and stores the pieces of EPG information in the EPG information storage unit 101.

The priority calculation unit 111 counts the number of occurrences of each category in the pieces of viewing history information of programs viewed in the past (the total number of programs in the category viewed in the past), calculates a priority of the category based on the number of occurrences, and stores the priority in the priority information storage unit 103.

If the pieces of viewing history information include subcategories, the priority calculation unit 111 counts the number of occurrences of each subcategory (the total number of programs in the subcategory viewed in the past), calculates a priority of the subcategory based on the number of occurrences, and stores the priority in the priority information storage unit 103.

The priority calculation unit 111 refers to the number of occurrences of each feature word in the pieces of viewing history information obtained by the program feature extraction unit 116 (to be described later) and calculates a priority of a program currently being broadcasted from the total number of occurrences of feature words contained in the program information of the program.

The priority calculation unit 111 may store in advance a feature word or a group of feature words to be weighted for each category or subcategory and calculate the priority of each program by weighting the number of occurrences of a corresponding feature word.

The priority calculation unit 111 performs weighting as shown in FIG. 4. As for a program in the “sports” category, if a feature word extracted from the EPG information of the program is “the name of a team”, the priority calculation unit 111 weights the number of occurrences of the feature word by “tripling the number of occurrences (×3)”. As for a program in a “drama” category, if a feature word extracted from the EPG information of the program is “the title of a series of a program”, the priority calculation unit 111 weights the number of occurrences of the feature word by “adding 10 to the number of occurrences (+10)”. If the feature word is “the name of a performer”, the priority calculation unit 111 weights the number of occurrences of the feature word by “doubling the number of occurrences (×2)”.

The displayed program control unit 112 obtains the EPG information of a program currently being broadcasted from the EPG information storage unit 101 at power-on of the television 1 or upon occurrence of a predetermined event serving as a trigger and selects one or more programs in a category or subcategory with the highest priority from among ones stored in the priority information storage unit 103. The displayed program control unit 112 generates viewing history information from the program information of a viewed program and stores the viewing history information in the viewing history information storage unit 102.

The user instruction reception unit 113 receives an instruction signal, which indicates a user instruction, transmitted from the remote control unit 2.

The program display processing unit 114 displays each of one or more programs selected by the displayed program control unit 112 with thumbnail screen size corresponding to the priority of the program on the display 115. Upon receipt of a user instruction to designate a program for viewing, the program display processing unit 114 displays the designated program with normal screen size on the display 115. The program display processing unit 114 displays, in an order determined by the displayed program control unit 112, programs with thumbnail screen size which is enlarged with correspond to a priority of category or subcategory.

The program feature extraction unit 116 extracts feature words from the viewing history information of each of programs viewed in the past, refers to the correspondence information, and identifies a subcategory whose associated feature words in the correspondence information match the most of the extracted feature words. The program feature extraction unit 116 adds the identified subcategory to the viewing history information.

The program feature extraction unit 116 extracts feature words from the EPG information of each of programs currently being broadcasted, refers to the correspondence information, and identifies a subcategory whose associated feature words in the correspondence information match the most of the extracted feature words. The program feature extraction unit 116 notifies the priority calculation unit 111 of the identified subcategory.

The program feature extraction unit 116 extracts feature words from all pieces of viewing history information and counts the number of occurrences of each feature word in the pieces of viewing history information. The program feature extraction unit 116 also extracts feature words from the EPG information of each of programs currently being broadcasted. The program feature extraction unit 116 notifies the priority calculation unit 111 of the number of occurrences of each feature word and the feature words in each program currently being broadcasted.

The subcategory setting unit 117 edits subcategories, the correspondence information, weights, and the like by a user's input operation.

The remote control unit 2 includes an instruction input unit 20 and an instruction transmission unit 21.

The instruction input unit 20 receives an instructional input indicating an object to be viewed referring to a desired program, switching of a category to be displayed, or the like which is inputted by a user's input operation.

The instruction transmission unit 21 transmits an instruction signal indicating an inputted user instruction to the television 1.

A method for selecting a program to be displayed in a thumbnail screen will be described.

The displayed program control unit 112 determines one or more programs to be displayed with thumbnail screen size based on the category or subcategory of the program. If a plurality of programs in the determined category or subcategory being broadcasted, selected are programs within such that the number of the program displayed with thumbnail screen size at a time or a program which falls into a category or subcategory having a priority exceeding a predetermined threshold value in the manner described below.

If programs to be displayed with thumbnail screen size are determined based on the priority of the category, a program to be displayed is selected by using the priorities of the subcategories of the category. More specifically, the programs are selected in descending order of subcategory priority based on the priorities of the subcategories of the category. Alternatively, ones of the programs in the category are selected in descending order of program priority using the program priorities of the programs in the category.

If programs in a subcategory with thumbnail screen size are determined based on the priority of the subcategory, a program to be displayed is selected by using the priorities of the programs in the subcategories. Alternatively, ones of the programs in the subcategory are selected as the programs to be displayed with thumbnail screen size in descending order of program priority using the program priorities of the programs in the subcategory.

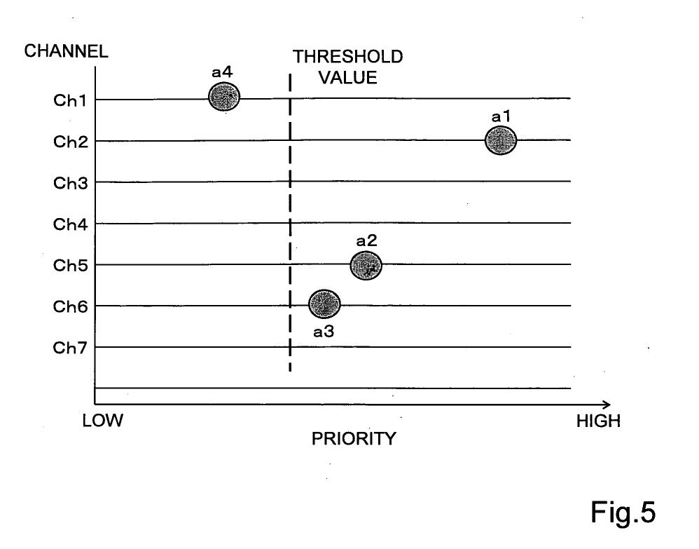

For example, assume that four programs a1 to a4 in a category “A” are selected as programs to be displayed in thumbnail screens. Also, assume that the programs a1 to a4 have program priorities as shown in FIG. 5. The programs a1 to a3 have program priorities above a priority threshold value.

The displayed program control unit 112 selects the programs a1 to a3 from among the programs a1 to a4 in the category “A” with the highest priority and notifies the program display processing unit 114 of the order of the programs a1 to a3 (in descending order of program priority).

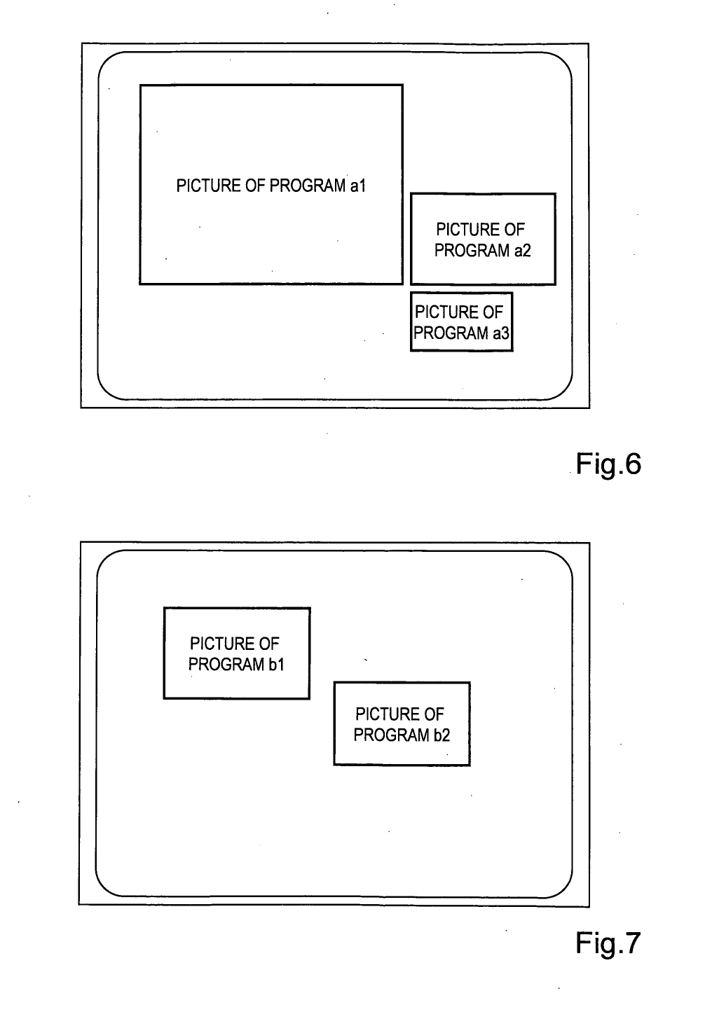

The program display processing unit 114 displays the programs a1 to a3 respectively in the order of the program a1, program a2, and program a3 in thumbnail screens, which are scaled down in size with increase in ordinal number on the display 115, as shown in FIG. 6.

If the user instruction reception unit 113 receives an instruction to switch from a category/subcategory into which programs displayed in thumbnail screens on the display 115 fall to another, the displayed program control unit 112 refers to the priority information storage unit 103 and identifies a category/subcategory having the highest priority next to that of the category/subcategory being displayed. The displayed program control unit 112 selects one or more programs in the identified category/subcategory in the above-described manner. For example, assume that the program display processing unit 114 is notified of the order of programs b1 and b2 in a category “B” which has the highest priority next to that of the category “A.”

The program display processing unit 114 displays the programs b1 and b2 in the category “B” in thumbnail screens, as shown in FIG. 7.

When a program is displayed in a normal screen on the display 115, the displayed program control unit 112 refers to pieces of EPG information in the EPG information storage unit 101. If there are programs which have started being broadcasted and are in a category/subcategory other than a category/subcategory into which the displayed program falls (a non-displayed category/subcategory), the displayed program control unit 112 selects one of the programs in the non-displayed category/subcategory.

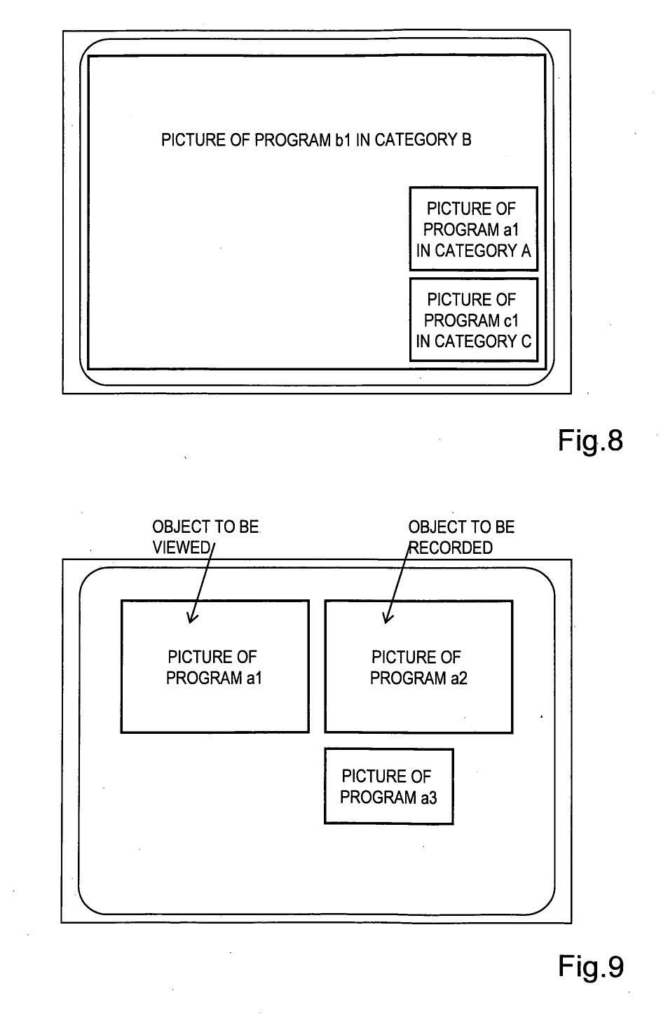

For example, when the program b1 in the category “B” is displayed in a normal screen, as shown in FIG. 8, the program display processing unit 114 displays programs in other categories, the program a1 in the category “A” and a program c1 in a category “C” in respective thumbnail screens.

If the program priorities of a plurality of programs displayed in thumbnail screens on the display 115 are not less than a predetermined value and fall within a predetermined range, the displayed program control unit 112 designates, as an object to be recorded, one of the plurality of programs which is not designated by a user as an object to be viewed. The displayed program control unit 112 notifies the program recording and playback device (not shown in FIG. 1), which works with the television 1, of a record instruction and stores the index information of the program to be recorded in the recorded program information storage unit 104.

If the program priorities of the programs a1 and a2 in the category “A” are almost equal, the program display processing unit 114 displays the programs a1 and a2 in the category “A” in thumbnail screens such that the thumbnail screens are almost the same size, as shown in FIG. 9. In this state, if a user selects the program a1 as an object to be viewed, the displayed program control unit 112 identifies the unselected program a2 as an object to be recorded and stores index information for identifying the recording information of the program a2 in the recorded program information storage unit 104. The program display processing unit 114 switches the display screen for the program a1 to a normal screen.

Processing according to the present invention will now be described with concrete examples.

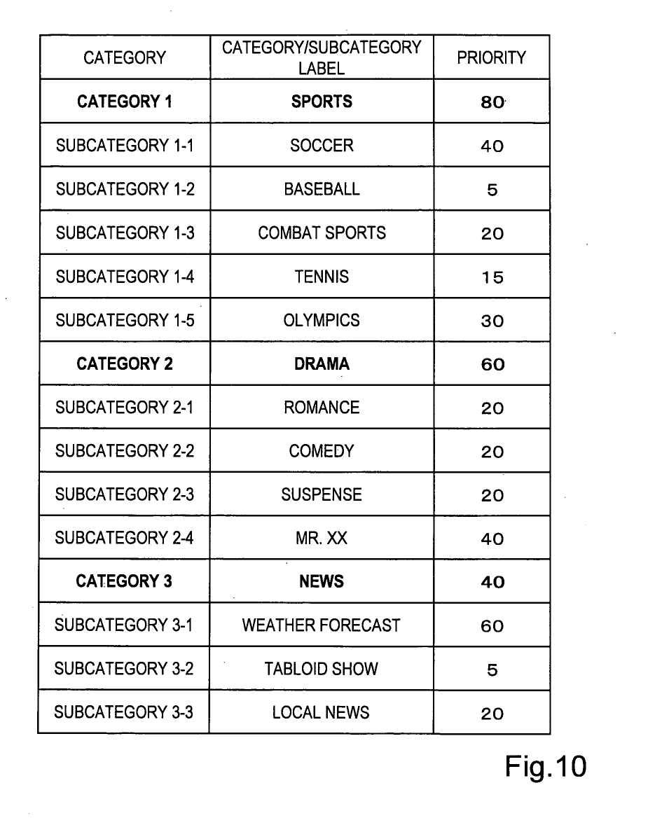

Assume that the priorities of categories and subcategories as shown in FIG. 10 are stored in the priority information storage unit 103.

At power-on of the television 1, the displayed program control unit 112 refers to the priority information storage unit 103. Since the priority of category 1 (“sports”) is the highest, it refers to pieces of EPG information and selects a program which is currently being broadcasted and in the “sports” category. Assume here that there are three programs in the “sports” category. The displayed program control unit 112 extracts feature words from each of the pieces of EPG information of the three programs in the “sports” category, refers to the correspondence information, and finds out that subcategories into which the programs fall are “soccer”, “baseball”, and “swimming.” When the number of displayed thumbnail screens is set to four (4), since the number of thumbnail screens to be displayed is not more than the set number, the displayed program control unit 112 selects the programs of “soccer”, “baseball”, and “swimming.” The displayed program control unit 112 stores the pieces of EPG information of the programs in the viewing history information storage unit 102 as pieces of viewing history information.

Since the priorities of the “soccer”, “baseball”, and “swimming” subcategories, into which the selected programs fall, are 40, 5, and 0 (0 means “unregistered”) respectively, the program display processing unit 114 displays the program of “soccer” in a large-size thumbnail screen, the program of “baseball” in a middle-size thumbnail screen, and the program of “swimming” in a small-size thumbnail screen on the display 115.

In this state, if a user selects the program of “soccer” as an object to be viewed, the program display processing unit 114 ends displaying the thumbnail screens for the two programs of “baseball” and “swimming” and displays the program categorized in the category “soccer” in a normal screen.

Assuming that a threshold value of difference between the priorities of the categories/subcategories into which the programs fall in order to determine a non-displayed program as an object to be recorded is set to “within twenty (20)”, the difference between the priority (40) of the program of “soccer” and that (5) of the program of “baseball” is 35, which exceeds the set threshold value. Accordingly, the displayed program control unit 112 does not set the program of “baseball” as an object to be recorded.

If the user selects the program in the subcategory “baseball”, the program display processing unit 114 ends displaying the thumbnail screens for the two programs in the subcategories “soccer” and “swimming” and displays the program categorized into the subcategory “baseball” in a normal screen. The displayed program control unit 112 sets the program of “soccer” having a higher priority as the object to be recorded, then notifies the program recording and playback device, and stores the index information of the program in the subcategory “soccer” in the recorded program information storage unit 104.

As described above, when the television 1 is turned on, it displays programs which are broadcasted currently and categorized in a category which is often selected by a user at the time of viewing and in order to check the programs at a glance. Thus, a user can select a desired program without checking a program schedule. Even if a user selects, as an object to be viewed, a program in a category which is not so often selected at the time of viewing in the past, a program in a category which is more often selected at the time of viewing is automatically recorded and saved when the program is being broadcasted. Accordingly, it is possible to avoid missing a desired program.

Since information in the viewing history information storage unit 102 has been updated, the priority calculation unit 111 of the television 1 updates the priorities of the category and subcategories. Assume that the number of viewing (the number of occurrences) is used as a priority without change. For example, if a program categorized into the “soccer” is selected as an object to be viewed, one point is given both to the “sports” category and the “soccer” subcategory (+1), and the priorities of the category and subcategory are updated.

If the priority of the subcategory “soccer” is updated by increasing only the number of viewing (the number of occurrences) for the subcategory “soccer”, and ten points in total are given to one or more subcategories in the “sports” category (+10), the priority of the category “sports” may be updated by giving one point to the category “sports” (+1).

Assume that three programs of “weather forecast”, “tennis”, and “suspense drama” start being broadcasted almost simultaneously when a user is viewing a program in the category “romantic drama” displayed in a normal screen. Also assume that the number of displayed thumbnail screens is set to two.

If programs whose priorities are to be compared are in a plurality of categories, the displayed program control unit 112 performs processing in the manner described below.

First, the displayed program control unit 112 identifies subcategories into which the started programs fall by the above-described processing. The displayed program control unit 112 obtains a piece of information for the program of “weather forecast” which falls into the category “news2 and has the priority of sixty (60), one for the program of “tennis” which falls into the category “sports” and has the priority of fifteen (15), and one for the program of “suspense drama” which falls into the category “drama” and has the priority of twenty (20) from information shown in FIG. 10. Then, The displayed program control unit 112 sets the priority of each program using the priorities of the category and subcategory, into which the program falls. A program priority is calculated here by “(category priority)×(subcategory priority)”. Accordingly, the priority of the program of “weather forecast” is 2,400 ((the priority of the category “news”:40)×(the priority of the subcategory “weather forecast”:60)). Similarly, the priority of the program of “tennis” is 1,200 ((the priority of the category “sports”:80)×(the priority of the subcategory “tennis”:15)), and the priority of the program of “suspense drama” is 1,200 ((the priority of the category “drama”:60)×(the priority of the subcategory “suspense”:20)).

The displayed program control unit 112 similarly calculates the priority of the program of “romantic drama” currently being displayed in the normal screen. The priority is 1,200 ((the priority of the category “drama”:60)×(the priority of the subcategory “romance”:20)).

The displayed program control unit 112 selects, as programs to be displayed in thumbnail screens, the program of “weather forecast” and one of the two programs of “tennis” and “suspense drama” equal in priority which has a higher category priority.

If the user is viewing the program displayed in the normal screen (the program b1 in FIG. 8), the program display processing unit 114 displays the programs of “weather forecast” and “tennis” (the programs a1 and c1 in FIG. 8) in thumbnail screens, as shown in FIG. 8.

If the user watch the thumbnail screens and selects the program of “weather forecast” as an object to be viewed, the program display processing unit 114 displays the program of “weather forecast” in a normal screen and stops displaying thumbnail screen for the program of “tennis”. The displayed program control unit 112 designates the program of “romantic drama” having been displayed in the normal screen as an object to be recorded and notifies the program recording and playback device of a record instruction.

If the user continues viewing the program of “romantic drama” for a certain period without switching to another program, the program display processing unit 114 terminates displaying the thumbnail screens. Since the priority of the program of “weather forecast”, having been displayed in the thumbnail screen, is higher than that of the program of “romantic drama” being viewed, the displayed program control unit 112 designates the program of “weather forecast” as the object to be recorded and notifies the program recording and playback device of a record instruction.

Note that if the priority of a program displayed in a thumbnail screen is lower than that of a program being viewed by a user, i.e., being displayed in a normal screen and is below a predetermined threshold value, the program displayed in the thumbnail screen is not designated as an object to be recorded.

As described above, a user can know the start of a program in a category often selected at the time of viewing even when the user is viewing another program. Additionally, collaboration between the television 1 and the program recording and playback device makes it possible to automatically record and save a program with a high priority. Accordingly, a user can avoid missing a desired program.

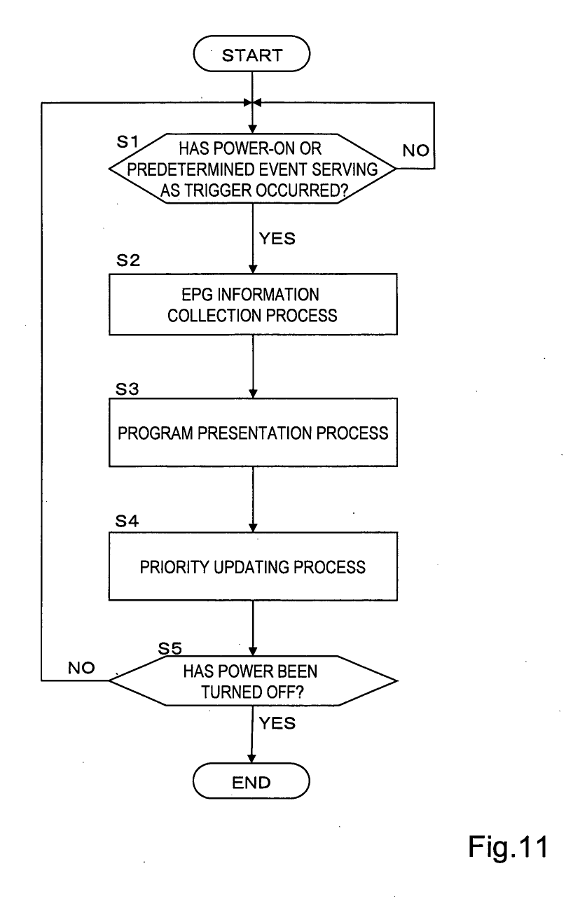

FIGS. 11 to 14 are each a chart showing the flow of a process according to the present invention. FIG. 11 is a chart showing the outline of the flow of a process for the television 1. In this process, a category priority is used as a priority for display. If a plurality of programs in a single category are being broadcasted, a program to be displayed is selected using subcategories into which the programs fall.

At power-on of the television 1 or upon occurrence of a predetermined event serving as a trigger (hereinafter abbreviated to “a predetermined time”) (step S1), the EPG information collection unit 110 performs an EPG information collection process (step S2), then the displayed program control unit 112 and program display processing unit 114 perform a program presentation process using a thumbnail screen (step S3). After that, the priority calculation unit 111 performs a priority updating process (step S4). Until it is determined that the television 1 has been turned off (step S5), the flow returns to the process in step S1, and the processes in steps S2 to S5 are repeated.

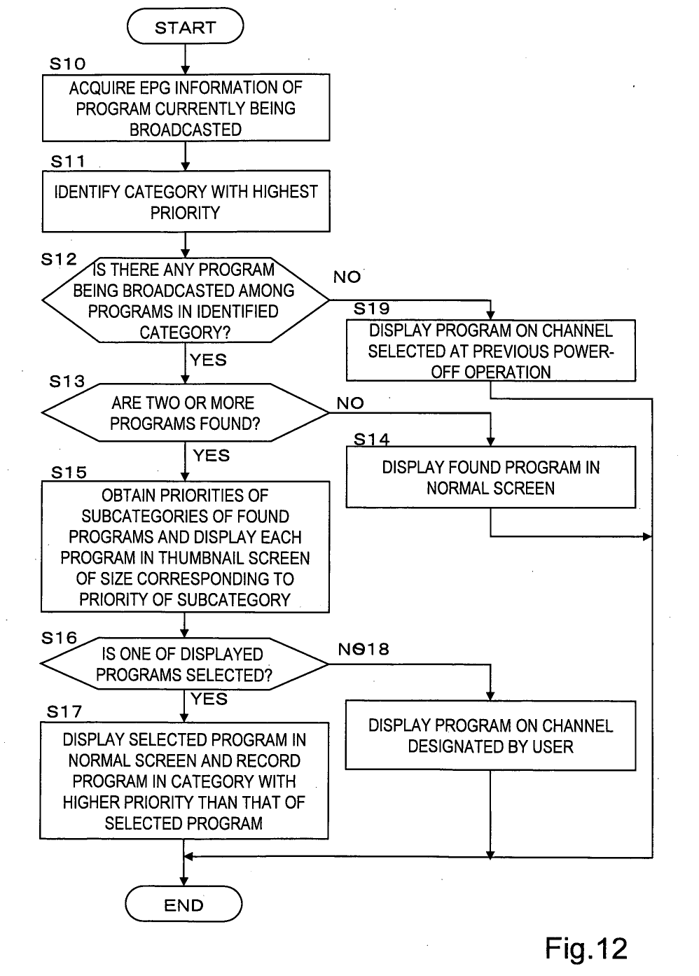

FIG. 12 is a chart showing the flow of a program presentation process at power-on.

The displayed program control unit 112 of the television 1 obtains the EPG information of a program currently being broadcasted from the EPG information storage unit 101 (step S10). The displayed program control unit 112 identifies a category with the highest priority based on the priorities of categories stored in the priority information storage unit 103 (step S11).

The displayed program control unit 112 checks whether there is any program categorized in the identified category and being broadcasted (step S12). If there is any such program being broadcasted (YES in step S12), the displayed program control unit 112 checks whether there are two or more such programs (step S13). If there are not two or more such programs (NO in step S13), the program display processing unit 114 displays the found program in a normal screen (step S14). On the other hand, if there are two or more such programs (YES in step S13), the displayed program control unit 112 selects a program/programs which is/are in a subcategory/subcategories with a priority/priorities not less than a predetermined threshold value from among the found programs in descending order of priority until the number of predetermined thumbnail screens are reached. The program display processing unit 114 displays the selected program (each of the selected programs) in a thumbnail screen of a size corresponding to the priority of the subcategory (step S15).

The displayed program control unit 112 checks whether the program (one of the programs) displayed in the thumbnail screens is selected by a user (step S16). If the program (one of the programs) displayed in the thumbnail screens is selected (YES in step S16), the program display processing unit 114 switches the display screen for the program selected by the user to a normal screen. If there is any program that is in a subcategory with a priority higher than that of a subcategory into which the selected program falls (one displayed in another thumbnail screen or a normal screen), the displayed program control unit 112 designates one of the found programs as an object to be recorded and records the program (step S17). If none of the program/programs displayed in the thumbnail screen/screens is selected (NO in step S16), the program display processing unit 114 displays a program on a channel designated by the user. If no channel is designated, the program display processing unit 114 continues displaying a currently displayed program in a normal screen (step S18).

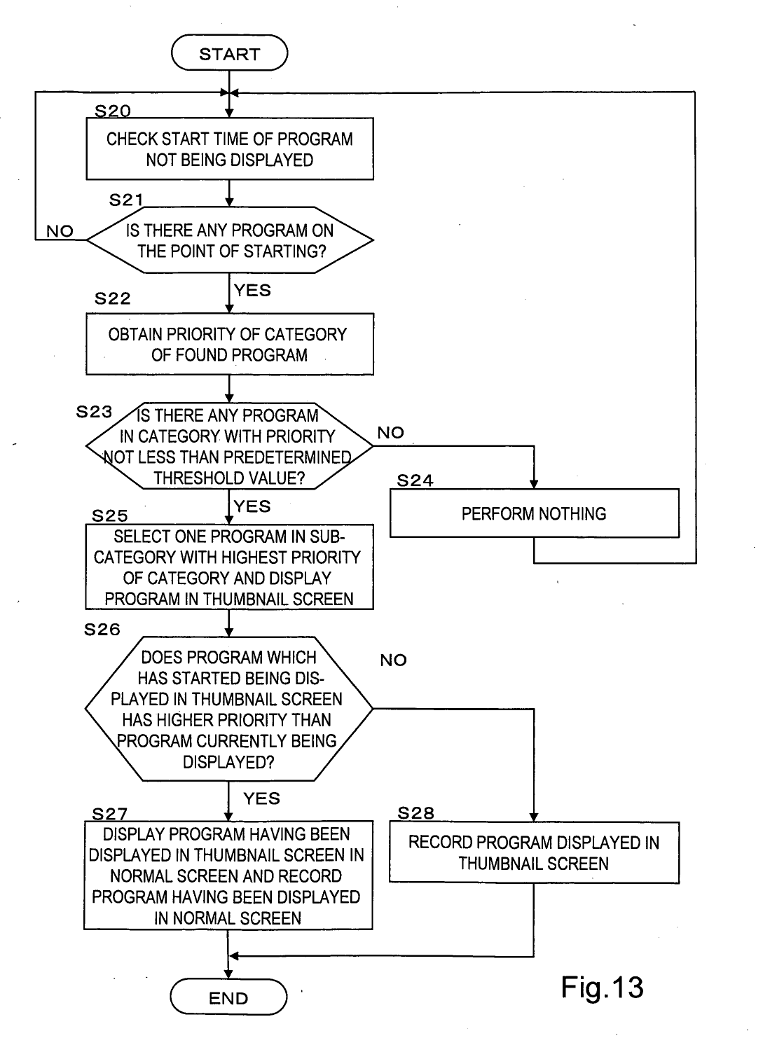

FIG. 13 is a chart showing the flow of a program presentation process when a user is viewing a certain program.

The displayed program control unit 112 of the television 1 refers to the EPG information storage unit 101 and checks the start time of a program which is not being displayed (step S20). If there is any program that is on the point of starting (YES in step S21), the displayed program control unit 112 obtains the priority of a category into which the found program (each of the found programs) falls (step S22) from the priority information storage unit 103. If the priority/priorities of the category/categories is/are less than a predetermined threshold value (NO in step S23), nothing is performed (step S24), and the flow returns to the process in step S20. On the other hand, if the priority (any of the priorities) is not less than the predetermined threshold value (YES in step S23), the program display processing unit 114 displays, for the category with the priority (each of the categories with the priorities) not less than the predetermined threshold value, the found program (one with the highest subcategory priority among ones of the found programs which are in the category) in a thumbnail screen (step S25).

The displayed program control unit 112 obtains the priority of a category into which a program currently being displayed in a normal screen falls and compares the priority with the category priority/priorities of the program/programs, which has/have started being displayed in the thumbnail screen/screens (step S26). If the category priority of the program (any of the category priorities of the programs), which has/have started being displayed in the thumbnail screen/screens, is higher than that of the program currently being displayed in the normal screen (YES in step S26), the program display processing unit 114 switches the display screen for the program being displayed in the thumbnail screen to a normal screen, and the displayed program control unit 112 designates the program having been displayed in the normal screen as an object to be recorded and records the program (step S27). On the other hand, if the category priority of the program. (the category priorities of the programs), which has/have started being displayed in the thumbnail screen/screens, is/are not higher than that of the program currently being displayed in the normal screen (NO in step S26), the displayed program control unit 112 designates the program (one of the programs) being displayed in the thumbnail screen/screens as the object to be recorded and records the program (step S28).

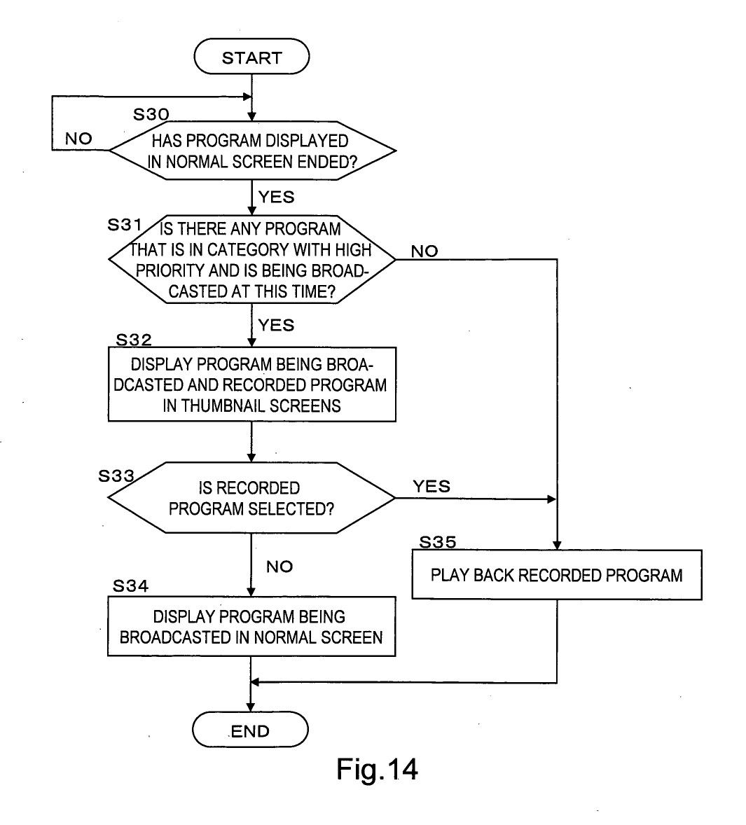

FIG. 14 is a chart showing the flow of a program presentation process upon termination of a program displayed in a normal screen.

Upon termination of a program being displayed in a normal screen (YES in step S30), the displayed program control unit 112 of the television 1 refers to the EPG information storage unit 101 and checks whether there is any program that is in a category with a priority higher than a predetermined value and is being broadcasted (step S31). If a program in a category with a higher priority is being broadcasted (YES in step S31), the displayed program control unit 112 refers to the recorded program information storage unit 104 and causes the program being broadcasted and a recorded and saved program to be displayed in thumbnail screens (step S32).

If the thumbnail screen for the recorded program is not selected by a user (NO in step S33), the program display processing unit 114 switches the display screen for the program currently being broadcasted to a normal screen (step S34). On the other hand, if the thumbnail screen for the recorded program is selected (YES in step S33), the displayed program control unit 112 notifies the program recording and playback device of the recorded and saved program and causes the program to be played back (step S35).

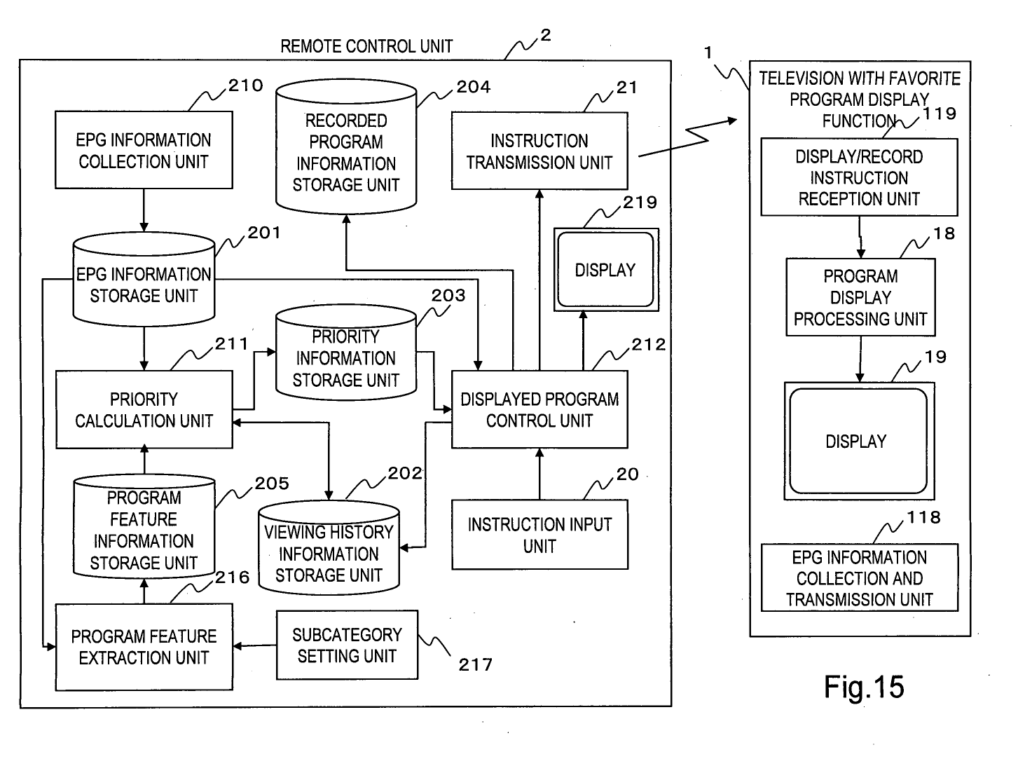

FIG. 15 is a diagram showing an example of a configuration in which the remote control unit 2 in FIG. 1 is equipped with a program presentation function and a priority updating function.

A remote control unit 2 in FIG. 15 includes an EPG information storage unit 201, a viewing history information storage unit 202, a priority information storage unit 203, a recorded program information storage unit 204, a program feature information storage unit 205, an EPG information collection unit 210, a priority calculation unit 211, a displayed program control unit 212, a program feature extraction unit 216, and a subcategory setting unit 217, in addition to an instruction input unit 20 and an instruction transmission unit 21. These processing units perform processes equivalent to those performed by the EPG information storage unit 101, viewing history information storage unit 102, priority information storage unit 103, recorded program information storage unit 104, program feature information storage unit 105, EPG information collection unit 110, priority calculation unit 111, displayed program control unit 112, program feature extraction unit 116, and subcategory setting unit 117 of the television 1 shown in FIG. 1. The remote control unit 2 also includes a display 219.

The displayed program control unit 212 of the remote control unit 2 displays a list of the titles of selected programs on the display 219 and transmits channel selection data indicating a broadcast station corresponding to a program selected by a user as an object to be viewed or information on a program serving as an object to be recorded to a television 1 through the instruction transmission unit 21.

The instruction input unit 20 supplies an input indicating the title of a program to be viewed selected from among a list of the titles of viewable programs displayed on the display 219 instead of thumbnail screens, an instructional input indicating switching of a displayed category, or the like.

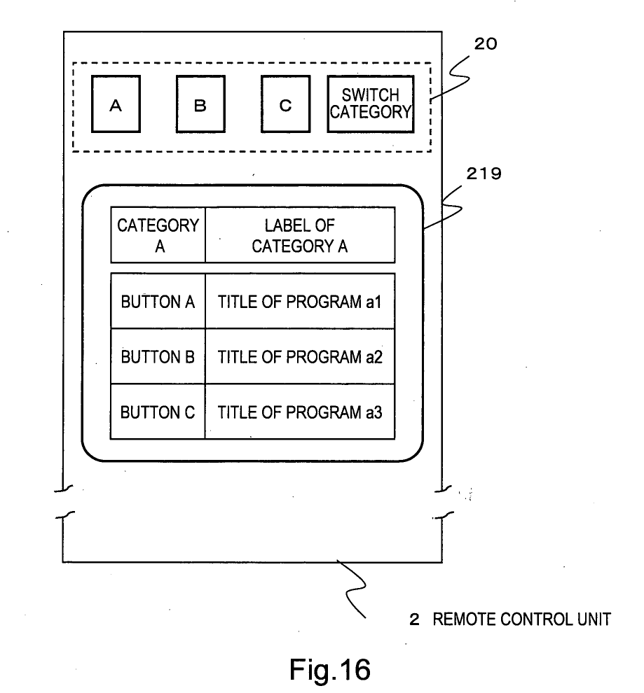

FIG. 16 shows examples of the instruction input unit 20 and the display 219 of the remote control unit 2.

Buttons A, B, and C forming a part of the instruction input unit 20 correspond to items A, B, and C in a list of viewable programs displayed on the display 219 and are each used to select a corresponding item. A category switching button is a toggle button used to select a category displayed on the display 219.

In this embodiment, the television 1 is composed of a program display processing unit 18, a display 19, an EPG information collection and transmission unit 118, and a display/record instruction reception unit 119, as shown in FIG. 15. The EPG information collection and transmission unit 118 collects pieces of EPG information and transmits the pieces of EPG information to the EPG information collection unit 210 of the remote control unit 2. The display/record instruction reception unit 119 receives instruction information transmitted from the instruction transmission unit 21 of the remote control unit 2.

With this configuration, a user can select one of programs denoted by a list of program titles displayed on the display 219 of the remote control unit 2. Accordingly, the user can perform an operation of selecting a program only with the remote control unit 2 in hand.

While the invention has been described with reference to preferred embodiments, it will be understood that various modifications may be made without departing from the spirit and scope of the invention.

What is claimed is:

1. A display device receiving and displaying a broadcast program and having a function of displaying a program favored by a user based on a program viewing history of the user, comprising:
a priority calculation unit which obtains viewing history information formed by accumulating respective pieces of information on programs viewed by the user, counts the number of occurrences of each of categories into which the viewed programs fall in the viewing history information, and calculates a priority of the category based on the number of occurrences;
a displayed program control unit which, upon occurrence of a predetermined event serving as a trigger, obtains a piece of program information of each of programs which is categorized in a predetermined one of the categories and being broadcasted among program information, identifies one of the categories which has a highest priority, and selects a program in the category from among the programs being currently broadcasted; and
a program display processing unit which displays the selected program.

2. The display device according to claim 1, further comprising:
a program feature information storage unit which stores correspondence information indicating a correspondence relationship between each of subcategories into which the programs are classified based on content of a program and a feature word which represents a feature of a program classified into the subcategory;
a program feature extraction unit which, upon occurrence of a predetermined event serving as a trigger, obtains a piece of program information of each of programs being broadcasted among program information, extracts, for each of the programs being broadcasted and the viewed programs, a feature word representing a feature of content of the program from the pieces of program information of the programs being broadcasted and the viewing history information, and identifies a subcategory into which the program falls based on the correspondence information, wherein
the priority calculation unit counts the number of occurrences of each of the subcategories in the viewing history information and calculates a priority of the subcategory based on the number of occurrences, and
the displayed program control unit identifies one of the subcategories which has a highest priority and selects a program in the subcategory from among the programs being broadcasted.

3. The display device according to claim 1, wherein
the program display processing unit displays one or more of the selected programs in each thumbnail screen with a predetermined size.

4. The display device according to claim 3, wherein
the program, display processing unit displays, in a normal screen, a program selected as the object to be viewed from the programs displayed in the thumbnail screen and terminates displaying all of the thumbnail screens for the programs except the program selected as the object to be viewed.

5. The display device according to claim 3, wherein
if the displayed program control unit receives an instruction to switch from the category, into which the program displayed in the thumbnail screen falls, to another category; the displayed program control unit identifies one of the categories which has a highest priority next to the priority of the category, into which the program displayed in the thumbnail screen falls, and selects a program in the identified category.

6. The display device according to claim 1, wherein
the displayed program control unit, while a broadcasted program is displayed in the normal screen, refers to the program information of each of the programs being currently broadcasted, then if there exists a program which has started being broadcasted and is not categorized into one of the categories or one of the subcategories, selects the program having started being broadcasted, and
the program display processing unit displays the selected program in a thumbnail screen.

7. The display device according to claim 1, wherein
the program feature extraction unit extracts feature words from the viewing history information, counts the number of occurrences of each of the extracted feature words in the viewing history information, extracts feature words from a piece of program information of each of the programs being broadcasted, and counts the number of occurrences of each of the extracted feature words in the piece of program information of the program being broadcasted,
the priority calculation unit calculates a program priority of each of the programs being broadcasted based on the total number of occurrences of the feature words in the piece of program information of the program being broadcasted while referring to the numbers of occurrences of the feature words in the viewing history information, and
the displayed program control unit selects a predetermined number of programs from among ones of the programs being broadcasted which are in one of the category with the highest priority and the subcategory with the highest priority in descending order of program priority.

8. The display device according to claim 7, wherein
the priority calculation unit stores a feature word or a group of feature words to be weighted for each of the categories or the subcategories and calculates a priority of each of the category or subcategory by setting weights to the number of occurrences of each of the one of the feature word or the group of feature words.

9. The display device according to claim 4, further comprising:
a recorded program storage unit which stores a recorded program; and
a program recording unit which records a currently broadcasted program which is designated as an object to be recorded and stores the program in the recorded program storage unit, wherein
if a priority of the program, which is displayed in the thumbnail screen and is selected as the object to be viewed, is not less than a predetermined value, the displayed program control unit designates a program which is not selected as the object to be viewed as an object to be recorded and notifies the program recording unit.

10. The display device according to claim 2, further comprising
a category editing unit which edits one of the subcategories or the correspondence information stored in the program feature information storage unit according to the an input operation of the user.

11. A remote control device for transmitting an instruction signal to a display device including a unit which receives an instruction signal and a program display processing unit which displays a program indicated by the instruction signal, comprising:
a priority calculation unit which obtains viewing history information formed by accumulating respective pieces of information on programs viewed by a user, counts the number of occurrences of each of categories into which the viewed programs fall in the viewing history information, and calculates a priority of the category based on the number of occurrences;
a displayed program control unit which, upon occurrence of a predetermined event serving as a trigger, obtains a piece of program information of each of programs which is in a predetermined one of the categories and being broadcasted among program information, identifies one of the categories which has a highest priority, and selects at least one program in the category from among the programs being broadcasted; and
an instruction signal transmission unit which displays a program title of the selected program and transmits an instruction signal designating one of the at least one program which is selected by the user as an object to be viewed to the display device.

12. The remote control device according to claim 11, further comprising:
a program feature information storage unit which stores correspondence information indicating a correspondence relationship between each of subcategories into which the programs are classified based on content of a program and a feature word representing a feature of a program which is classified into the subcategory;
a program feature extraction unit which, upon occurrence of a predetermined event serving as a trigger, obtains a piece of program information of each of programs being broadcasted among program information, extracts, for each of the programs being broadcasted and the viewed programs, a feature word representing a feature of content of the program from the pieces of program information of the programs being broadcasted and the viewing history information, and identifies a subcategory into which the program falls based on the correspondence information, wherein
the priority calculation unit counts the number of occurrences of each of the subcategories in the viewing history information and calculates a priority of the subcategory based on the number of occurrences, and
the displayed program control unit identifies one of the subcategories which has a highest priority and selects a program in the subcategory from among the programs being broadcasted.

13. The remote control device according to claim 11, wherein
the program feature extraction unit extracts feature words from the viewing history information, counts the number of occurrences of each of the extracted feature words in the viewing history information, extracts feature words from a piece of program information of each of the programs being broadcasted, and counts the number of occurrences of each of the extracted feature words in the viewing history information,
the priority calculation unit calculates a program priority of each of the programs being broadcasted based on the total number of occurrences of the feature words in the piece of program information of the program being broadcasted while referring to the numbers of occurrences of the feature words in the viewing history information, and
the displayed program control unit selects a predetermined number of programs from among the programs being broadcasted and categorized in one of the category with the highest priority and the subcategory with the highest priority in descending order of program priority.

14. The remote control device according to claim 11, wherein
the priority calculation unit stores a feature word and a group of feature words to be weighted for each of one of the categories and the subcategories and calculates one of the priority of the category and the priority of the subcategory by setting weights to the number of occurrences of each of the one of the feature word or the group of feature words.

15. The remote control device according to claim 11, further comprising
a category editing unit which edits the subcategories and the correspondence information stored in the program feature information storage unit according to an input operation of the user.
